(19) United States
(12) Patent Application Publication
(10) Pub. No.: US 2010/0095845 A1
(43) Pub. Date: Apr. 22, 2010

(54) VENT GAS ABSORPTION SYSTEM AND METHOD FOR RECOVERY VOCs

(75) Inventors: Kyeong-Soo MOK, Yeosu-city (KR); Haeng-Seok LEE, Yeosu-city (KR); Seon-Bok WI, Yeosu-city (KR); Duk-Kyun CHUNG, Yeosu-city (KR); Jong-Ha KIM, Yeosu-city (KR); Tae-Jung KIM, Yeosu-city (KR)

Correspondence Address: CANTOR COLBURN, LLP, 20 Church Street, 22nd Floor, Hartford, CT, 06103, US

(73) Assignee: LG CHEM, LTD., Seoul (KR)

(21) Appl. No.: 12/603,989

(22) Filed: Oct. 22, 2009

Related U.S. Application Data
(63) Continuation-in-part of application No. 10/547,864, filed on Sep. 2, 2005.

(30) Foreign Application Priority Data
Mar. 4, 2003 (KR) 10-2003-0013462

(51) Int. Cl. B01D 53/14

(52) U.S. Cl. 95/166; 96/181; 96/173; 95/159

(57) ABSTRACT

The present invention relates to a vent gas adsorption system and a method of recovering volatile organic compounds (VOCs), more particularly to a vent gas adsorption system devised to effectively adsorb VOCs included in the vent gas and reduce VOC content of the vent gas, and a method of recovering VOCs.

### CROSS-REFERENCE TO RELATED PATENT APPLICATION

This application is a continuation-in-part of U.S. patent application Ser. No. 10/547,864, filed on Sep. 2, 2005, and claims the benefit of the filing dates of PCT/KR2004/000459, filed on Mar. 4, 2004 and Korean Patent Application No. 10-2003-0013462, filed on Mar. 4, 2003, the contents of which in their entireties are herein incorporated by reference.

### BACKGROUND OF THE INVENTION

(a) Field of the Invention

The present invention relates to a vent gas adsorption system and a method of recovering volatile organic compounds (VOCs), more particularly to a vent gas adsorption system devised to effectively adsorb VOCs included in the vent gas and reduce VOC content of the vent gas, and a method of recovering VOCs.

(b) Description of the Related Art

The membrane separation system, core cooling system, absorption system, adsorption system and combinations thereof are known as techniques to remove and recover VOCs from vent gas.

For the adsorption system, a method of effectively removing VOCs by feeding polluted air to an adsorption tower filled with silica gel and active carbon is disclosed in Korea Patent Registration No. 266479.

And, Korea Patent Publication No. 2002-10384 discloses a method and an apparatus of continuously recycling the absorbent at the moderate temperature by vacuum and separating and recovering VOCs included in the vent gas.

However, the above-mentioned techniques do not effectively recover VOCs. Moreover, they cost much to install and maintain because of complicated structures.

FIG. 3 is a schematic diagram of the conventional VOC recovery and adsorption system for PVC manufacturing process. As seen in the figure, VCM vented from the separation tank 100 and the condenser 110 is compressed by the gas holder 120 or directly discharged at the active carbon tower 140 passing through the second condenser 130. Or, it is combusted at the combustion unit 150 before being transferred to the second condenser 130.

The conventional system is not suitable for the large scale and the combustion process generates the problem of treating waste gas.

### BRIEF DESCRIPTION OF THE DRAWINGS

FIG. 1 is a schematic diagram of the vent gas adsorption system of the present invention,

FIG. 2 is the cross-sectional view of the distributor of the vent gas adsorption system of the present invention.

FIG. 3 is a schematic diagram of the conventional vent gas adsorption system,

### SUMMARY OF THE INVENTION

Thus, it is an object of the present invention to provide a vent gas adsorption system capable of minimizing VOC content of the vent gas and a method of recovering VOCs using the same.

It is another object of the present invention to provide a vent gas adsorption system capable of improving VOC recovery yield by optimizing transfer and residence time of gaseous and liquid materials in the adsorption tower and the desorption tower and a method of recovering VOCs using the same.

### DETAILED DESCRIPTION OF THE PREFERRED EMBODIMENTS

The vent gas adsorption system of the present invention feeds vent gas including VOC components into the adsorption tower, which optimizes the gas-liquid contact through counter-current flow, flows adsorption solvent into the adsorption tower so that the VOC components of the vent gas are adsorbed, transfers it to the desorption tower so that the VOC components adsorbed to the adsorption solvent are desorbed by thermal energy and recovered at the reprocessing process. As a result, inert gas with no VOC components is discharged into the air.

For this purpose, the present invention provides a vent gas adsorption system comprising an adsorption tower, which adsorbs VOC components included in the vent gas with circulating adsorption solvent and discharges gas with no VOCs to the outside, a desorption tower, which separates the VOC components from the adsorption solvent and recovers them with circulating carrier gas, and a storage tank that stores adsorption solvent, wherein the removed gas is discharged via the storage tank to the outside.

The desorption tower may be connected to the storage tank by a first recovery line, and the removed gas may flow through the first recovery line to the storage tank.

The vent gas adsorption system of the present invention may further comprise a temperature control unit to cool or heat the adsorption solvent appropriate for the operating condition of the adsorption tower and the desorption tower.

For this purpose, a heat exchanger that heats the adsorption solvent flowing into the desorption tower and cools the adsorption solvent flowing into the adsorption tower by heat exchange of the two adsorption solvents may be used as the temperature control unit.

And, the heat exchanger may further comprise a cooler that cools the adsorption solvent flowing into the adsorption tower and a heater that heats the adsorption solvent flowing into the desorption tower.

The adsorption tower has a gas distributor, which distributes inert vent gas into the adsorption tower, at the bottom and a solvent distributor, which distributes VOC adsorption solvent to the bottom of the adsorption tower, at the top. Also, it is equipped with a transfer line, which transfers the adsorption solvent having adsorbed VOC components into the desorption tower, at the bottom. The adsorption tower has several plates between the top and the bottom, which are filled with packing materials enabling optimum contact of gaseous and liquid materials.

Preferably, fluid silicone oil or other silicon based compound is used for the adsorption solvent.

And, the desorption tower has a distributor, which is connected to the transfer line and distributes the adsorption solvent into the desorption tower, at the top and a discharge line, which transfers the VOC components separated from the adsorption solvent to the reprocessing process with carrier gas, at the bottom. The desorption tower has several plates between the top and the bottom, which are filled with packing materials enabling optimum contact of gaseous and liquid materials.

The feeding line at the side of the desorption tower may be connected to the transfer line at the side of the desorption tower by a recycle line, and at least a portion of the adsorption solvent from the desorption tower may be re-introduced into the desorption tower through the recycle line

Preferably, the temperature of the carrier gas is controlled to be higher than the boiling point of VOCs.

The vent gas adsorption system of the present invention may further comprise a separator, which separates the adsorption solvent from the carrier gas at the discharge line, and a second recovery line, which connects the separator and the desorption tower and re-feeds the separated adsorption solvent into the desorption tower.

The present invention also provides a method of recovering VOCs comprising the steps of: contacting vent gas with adsorption solvent to adsorb the VOC components included in the vent gas; feeding hot carrier gas to the adsorption solvent having adsorbed the VOC components to separate the VOC components from the adsorption solvent; transferring the separated VOC components to the reprocessing process with the carrier gas for recovery and treatment; and re-circulating the adsorption solvent with the VOC components removed to the adsorption step.

The method of recovering VOCs of the present invention may further comprise the step of heating the adsorption solvent prior to the VOC separation step.

The method of recovering VOCs of the present invention may further comprise the step of separating adsorbed materials included in the carrier gas while transferring the carrier gas.

Hereinafter, a preferred embodiment of the present invention is described in detail referring to the attached drawings.

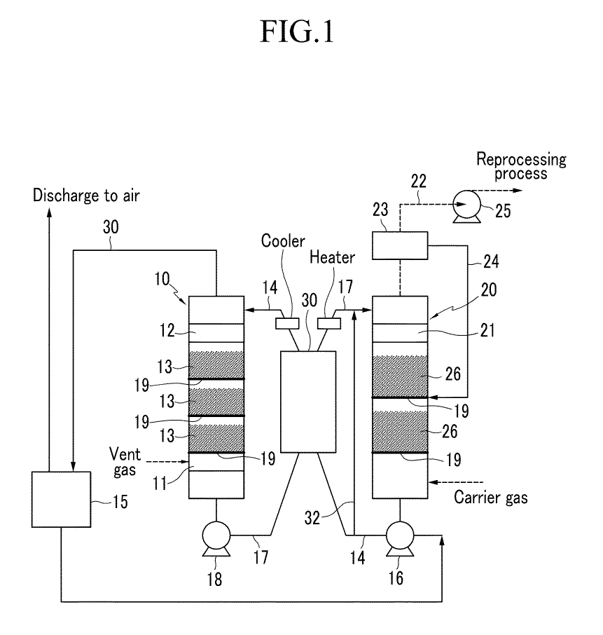

FIG. 1 is a schematic diagram of the vent gas adsorption system of the present invention.

A process of recovering vinyl chloride monomers (hereinafter referred to as “VCM”) included in the vent gas generated in the polyvinyl chloride (PVC) manufacturing process is described as an example.

The following example is only for the understanding of the present invention, and the present invention is not limited by the following example.

As seen in FIG. 1, the vent gas adsorption system of the present invention comprises an adsorption tower 10, which adsorbs VCM gas from inert gas with adsorption solvent, and a desorption tower 20, which recovers the VCM gas adsorbed to the adsorption solvent.

At the adsorption tower 10, a gas distributor 11 at the bottom distributes the inert gas into the adsorption tower 10, and the gas distributed by the gas distributor 11 is discharged into the air at the top of the adsorption tower 10 with the VCM gas removed.

On top of the adsorption tower 10, there is a solvent distributor 12 which distributes the VCM gas adsorption solvent to the bottom of the adsorption tower 10. The solvent distributor 12 is connected with a storage tank 15 storing the adsorption solvent through a feeding line 14. A transfer pump 16 on the feeding line 14 feeds the adsorption solvent.

The storage tank 15 is connected to the top of the adsorption tower 10 by a first recovery line 30. The removed gas is discharged from the adsorption tower 10 and then flows through the first recovery line 30 into the storage tank 15. A portion of adsorption solvent as well as the removed gas may be discharged from the adsorption tower 10. The discharged adsorption solvent, together with the removed gas, moves through the first recovery line 30 into the storage tank 15.

The adsorption solvent is a liquid and has a greater specific gravity than the removed gas. Because of the difference in specific gravity, the adsorption solvent and the removed gas are separated within the storage tank 15. That is, the adsorption solvent remains within the storage tank 15 and the removed gas is discharged into the air.

If the removed gas is directly discharged from the adsorption tower 10 to the air, some of the adsorption solvent can be discharged together with the removed gas. According to the embodiment of the invention, however, the removed gas moves into the storage tank 15, and then is separated from the adsorption solvent and discharged into the air. Therefore, the waste of the adsorption solvent can be prevented.

In this example, a fluid silicon based compound is used as the adsorption solvent.

At the bottom of the adsorption tower 10, there is a transfer line 17 which transfers the adsorption solvent having adsorbed the VCM gas to the desorption tower 20. The transfer line 17 is also equipped with a transfer pump 18.

Thus, the VCM gas is adsorbed to the continuously and uniformly circulating adsorption solvent in the adsorption tower 10 and then discharged into the air. Resultantly, the VCM content of the inert gas discharged into the air is maintained at 10 ppm or below.

The desorption tower 20 separates the VCM gas from the adsorption solvent and transfers it to the reprocessing process. At the top of the desorption tower 20, there is a distributor 21 which is connected to the transfer line 17 and distributes the adsorption solvent into the desorption tower 20. The carrier gas that transfers the VCM gas separated from the adsorption solvent is fed at the bottom of the desorption tower 20. On top of the desorption tower 20, there is a discharge line 22 which discharges the carrier gas containing the VCM gas.

Preferably, steam of 200° C. or below is used for the carrier gas.

The adsorption solvent and the VCM gas are separated in the desorption tower 20 and fed again into the adsorption tower 10 through the feeding line 14 at the bottom of the desorption tower 20. In this process, any adsorption solvent flowing into the discharge line 22 along with the carrier gas needs to be recovered.

For this purpose, a separator 23 which separates the adsorption solvent from the carrier gas is installed on top of the discharge line 22. This separator 23 is connected to the desorption tower 20 by a recovery line 24, so that the separated and recovered adsorption solvent is fed again into the desorption tower 20.

On the other hand, the feeding line 14 at the side of the desorption tower 20 can be connected to the transfer line 17 a the side of the desorption tower 20 by a recycle line 32. In this case, at least a portion of the adsorption solvent that is discharged from the desorption tower 20 moves through the recycle line 32 and then is re-introduced into the desorption tower 20. The re-introduced adsorption solvent undergoes the desorption process again such that more of the VCM gas is desorbed. The adsorption solvent that is transferred to the adsorption tower 10 after the recycle process has less of the VCM gas and thus is able to adsorb more VCM gas in the adsorption tower 10. This recycle process can be repeated more than once.

The discharge line 22 is equipped with a vacuum pump 25 which transfers the carrier gas containing the VOC components to the reprocessing process.

The adsorption tower 10 and the desorption tower 20 are separated by several plates which optimize the transfer and residence time of gaseous and liquid materials. Each plate is filled with packing materials 13, 26.

Preferably, the adsorption tower 10 is separated by three plates and the desorption tower 20 is separated by two plates.

Each plate is separated by a horizontal lattice 19. The lattice 19 has tiny holes impermeable to the packing materials 13, 26. About 75% of the space between each plate is filled with the packing materials.

The packing materials 13, 26 optimize contact of gaseous and liquid materials during their transfer. 25% or less liquid holdup is preferable (The liquid holdup means the volume proportion of liquid sticking to the packing. A low liquid holdup enables optimum contact.).

A heat exchanger 30 is installed on the feeding line 14 and the transfer line 17 between the adsorption tower 10 and the desorption tower 20 and changes thermal energy of the adsorption solvents circulated through the adsorption tower 10 and the desorption tower 20. A cooler and a heater are installed in series with the heat exchanger to further cool or heat the adsorption solvent transferred to each line.

That is, a cooler is installed on the feeding line 14 connected to the adsorption tower 10, and the adsorption solvent having been cooled passing through the heat exchanger is further cooled appropriate for the operating condition of the adsorption tower. And, a heater is installed on the transfer line 17 connected to the desorption tower 20, and the adsorption solvent having been heated passing through the heat exchanger is further heated appropriate for the operating condition of the desorption tower.

Considering that the preferable operating temperature of the adsorption tower 10 is 0 to 50° C. and that of the desorption tower 20 is 60 to 150° C., it is preferable that the temperature of each adsorption solvent is controlled to 0 to 35° C. and 95 to 100° C. by the cooler and the heater.

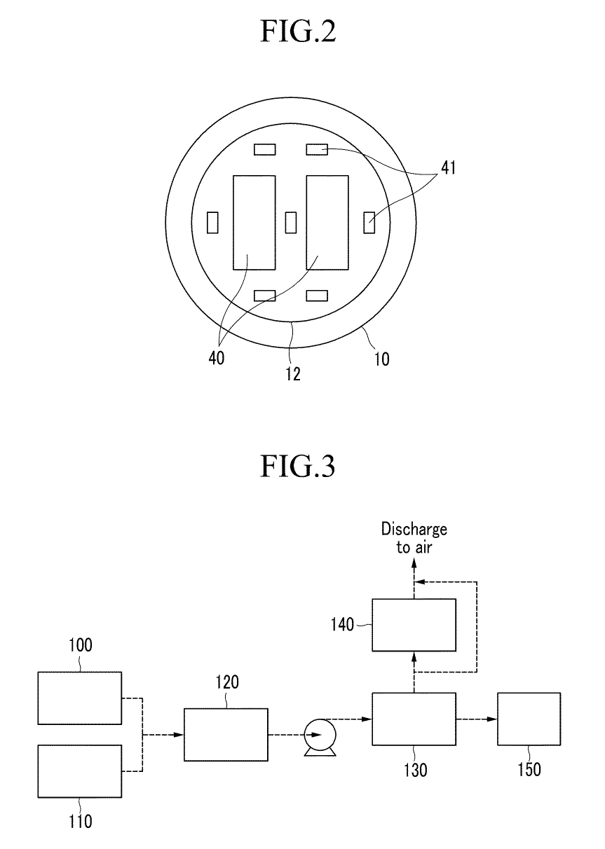

It is preferable that each distributor can prevent flooding or weeping during transfer of gaseous and liquid materials in each tower. For this purpose, each distributor has different paths for the adsorption solvent and the gas, which enables flow of the adsorption solvent and the gas without interruption. FIG. 2 is an exemplary cross-sectional view of the solvent distributor 12 of the adsorption tower 10. It has a path 40 for the gas and a path 41 for the adsorption solvent.

The vent gas adsorption system of the present invention is operated as follows.

When a pump installed on each line operates, fluid adsorption solvent contained in the storage tank 15 is fed to the solvent distributor 12 at the top of the adsorption tower 10 through the feeding line 14. Then, it flows downward passing through each plate of the adsorption tower 10.

The gas distributor 11 at the bottom of the adsorption tower 10 uniformly feeds vent gas to the top of the adsorption tower 10.

Thus, the adsorption solvent and the vent gas contact in the adsorption tower 10 and the VCM gas contained in the vent gas is adsorbed to the adsorption solvent. In this process, the packing materials 13 filled in the adsorption tower 10 and each plate optimize pressure difference, residence time of gaseous and liquid materials and their contact state, so that VCM gas adsorption by the adsorption solvent is maximized.

While the vent gas is transferred to the top of the adsorption tower 10, the VCM gas is removed and the vent gas is discharged into the air through the top of the adsorption tower 10.

According to a test, the VCM content of the inert gas discharged into the air was below 10 ppm.

The adsorption solvent having adsorbed the VCM gas flows downward to the bottom of the adsorption tower 10. There, it is transferred to the top of the desorption tower 20 through the transfer line 17 by the transfer pump 18. Before being fed to the desorption tower, it passes through the heat exchanger 30. The heat exchanger 30 exchanges thermal energy of the adsorption solvent having adsorbed the VCM gas and the adsorption solvent having the VCM gas desorbed.

As a result, the adsorption solvent transferred to the adsorption tower 10 is cooled by thermal energy loss, while the adsorption solvent transferred to the desorption tower 20 is heated by thermal energy gain.

In this process, if each tower is equipped with a cooler and a heater, the temperature of the adsorption solvent can be set more favorably according to the operating condition.

In the desorption tower 20, the VCM gas is separated from the adsorption solvent at the boiling point. In this process, the packing materials 26 filled in each plate of the desorption tower 20 maintains optimum residence time and contact state of the gaseous and liquid materials, thereby further increasing the desorption efficiency.

The separated VCM gas is transferred to the reprocessing process by the carrier gas fed through the bottom of the desorption tower 20. That is, the carrier gas containing the VCM gas is transferred to the reprocessing process through the discharge line 22 by the vacuum pump 25.

While the carrier gas passes through the separator 23 installed on the discharge line 22, the adsorption solvent is separated and fed again into the desorption tower 20 through the recovery line 24.

The adsorption solvent removed from the VCM gas in the desorption tower is fed again into the adsorption tower 10 through the feeding line 14 connected to the bottom of the desorption tower 20 for VCM gas adsorption.

The vent gas adsorption system of the present invention described above minimizes the VOC content of the vent gas discharged into the air, thereby improving VOC recovery and preventing environmental pollution.

While the present invention has been described in detail with reference to the preferred embodiment, those skilled in the art will appreciate that various modifications and substitutions can be made thereto without departing from the spirit and scope of the present invention as set forth in the appended claims.

What is claimed is:

1. A vent gas adsorption system comprising:
an adsorption tower which adsorbs volatile organic compound (VOC) components contained in vent gas by circulating adsorption solvent therein, and discharges the removed gas with the VOC components to the outside;
a desorption tower which separates the VOC components from the adsorption solvent and recovers the VOC components by circulating a carrier gas therein; and
a storage tank that stores adsorption solvent,
wherein the removed gas is discharged via the storage tank to the outside.

2. The vent gas adsorption system of claim 1, wherein the desorption tower is connected to the storage tank by a first recovery line, and
wherein the removed gas flows through the first recovery line to the storage tank.

3. The vent gas adsorption system of claim 1, further comprising a temperature control unit which controls the temperature of the adsorption solvent transferred to the adsorption tower and the desorption tower to be appropriate for the operating condition of each tower.

4. The vent gas adsorption system of claim 3, said temperature control unit being a heat exchanger which cools and heats the adsorption solvent separated from the desorption tower and the adsorption solvent transferred from the adsorption tower to the desorption tower by heat exchange appropriate for the operating conditions of each tower.

5. The vent gas adsorption system of claim 4, said heat exchanger further comprising a cooler and a heater on a feeding line and a transfer line connected to the adsorption tower and the desorption tower, so as to cool and heat the adsorption solvent transferred to the adsorption tower and the desorption tower.

6. The vent gas adsorption system of claim 1, said adsorption tower being equipped with: a gas distributor at the bottom thereof, which distributes inert vent gas into the adsorption tower; a solvent distributor at the top thereof, which distributes VOC adsorption solvent to the bottom of the adsorption tower; a transfer line at the bottom thereof, which transfers the adsorption solvent having adsorbed the VOC components to the desorption tower; and several plates between the top and the bottom thereof, which are filled with packing materials that optimize contact of gaseous and liquid materials.

7. The vent gas adsorption system of claim 1, said adsorption solvent being silicone oil another silicon-based compound.

8. The vent gas adsorption system of claim 6, said desorption tower being equipped with: a distributor at the top thereof, which is connected to a transfer line and distributes the adsorption solvent into the desorption tower; a discharge line at the top thereof, which is connected to the reprocessing process; and several plates between the top and the bottom thereof, which are filled with packing materials that optimize contact of gaseous and liquid materials, and the carrier gas transferring the VOC components separated from the adsorption solvent to the reprocessing process fed from the bottom.

9. The vent gas adsorption system of claim 8, wherein the feeding line at the side of the desorption tower is connected to the transfer line at the side of the desorption tower by a recycle line, and
wherein at least a portion of the adsorption solvent from the desorption tower is re-introduced into the desorption tower through the recycle line.

10. The vent gas adsorption system of claim 10, the temperature of said carrier gas being higher than the boiling point of the VOC components.

11. The vent gas adsorption system of claim 10, said discharge line being equipped with a separator, which separates the adsorption solvent from the carrier gas and again feeds the separated adsorption solvent into the desorption tower through a recovery line.

12. A method of recovering VOC components contained in vent gas using the system of claim 1.

13. The method of recovering the VOC components of claim 12 comprising the steps of:
contacting the vent gas with adsorption solvent to adsorb the VOC components contained in the vent gas;
feeding hot carrier gas to the adsorption solvent having adsorbed the VOC components to separate them from the adsorption solvent;
transferring the VOC components with the carrier gas to a reprocessing process and recovering them; and
re-circulating the adsorption solvent with the separated VOC components to the VOC adsorption step.

14. The method of recovering the VOC components of claim 13 further comprising the step of heating the adsorption solvent prior to the VOC component separation step.

15. The method of recovering the VOC components of claim 13 further comprising the step of separating materials adsorbed to the carrier gas during the carrier gas transfer.
